(19) United States
(12) Patent Application Publication
(10) Pub. No.: US 2010/0104770 A1
(43) Pub. Date: Apr. 29, 2010

(54) TWO-STEP FORMATION OF HYDROCARBON-BASED POLYMER FILM

(75) Inventor: Kamal Kishore Goundar, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: ASM JAPAN K.K., Tokyo (JP)

(21) Appl. No.: 12/259,129

(22) Filed: Oct. 27, 2008

(51) Int. Cl. H05H 1/46

(52) U.S. Cl. 427/569

(57) ABSTRACT

A method of forming a surface-treated hydrocarbon-based polymer film includes: supplying a hydrocarbon gas as a source gas, and an inert gas, and applying RF power to generate a plasma and form a hydrocarbon-based principal film on a substrate; and without extinguishing a plasma, changing flow of the hydrocarbon gas and the inert gas by continuously decreasing a flow ratio of the hydrocarbon gas to the inert gas with time to treat a surface of the principal film on the substrate.

### BACKGROUND

1. Field of the Invention

The present invention relates to a method of forming a hydrocarbon-based polymer film by plasma CVD.

2. Description of the Related Art

In semiconductor processing techniques, optical films such as antireflective films and hard masks are used. In conventional techniques, these films are formed mainly by a technique called a coating method. The coating method forms highly functional polymer films by coating a liquid material and sintering it. It is, however, difficult to form a thin film on a substrate using this method because the liquid tend to have high viscosity. Furthermore, it is also difficult to control the refractive index and extinction coefficient of the films formed according to the above mentioned coating method. As semiconductor chip sizes continue to shrink, thinner, high-strength and high transparent films are required.

As an advantageous method for achieving formation of such films, formation of a DLC (diamond-like carbon) film or an amorphous carbon film by plasma CVD has been reported (e.g., U.S. Pat. No. 5,470,661, U.S. Pat. No. 6,428,894). In these cases, using a molecule which is gaseous at room temperature as a precursor material, a diamond-like carbon film or an amorphous carbon film is formed by decomposing the molecules using a plasma. Using a plasma CVD method is promising for facilitating formation of thinner films and, further, the refractive index and extinction coefficient can also be controlled.

Polymer materials produced from organic monomers having high molecular weights (e.g., having five or more carbon atoms), such as benzene, can achieve wide varieties of structures and characteristics and can be widely and industrially used as high-strength materials and produce various highly functional materials. By plasma polymerization of these organic monomers, it becomes possible to form a thin-film hard mask having excellent mechanical and optical characteristics.

In the above, in CVD where the liquid monomer having a benzene structure is used, a polymer having a density of about 0.9 to about 1.2 g/cm³ and an extinction coefficient of about 0.01 to about 0.15 for optical light at a wavelength of 633 nm can be formed by sufficiently incorporating the benzene structure into the polymer structure. However, this film's stress and extinction coefficient are altered, change or drift when the film is either exposed to light or has a direct contact to the atmospheric environment. This is due to oxidation of the top surface of the film. One method of minimizing the oxidation of carbon-containing materials, such as silicon carbide, by using a plasma of an inert gas such as helium (He) and argon (Ar), is published in JP Patent Laid-open 2001/0060584 and corresponding US patent publication No. 2002/0054962.

### SUMMARY

In view of the above, in an embodiment of the present invention, by performing an active plasma treatment after a film forming sequence is substantially or nearly complete using a hydrocarbon monomer which is, for example, either unsaturated or has a benzene structure, a highly stable hydrocarbon-based polymer film having a density of, for example, more than 1.0 g/cm³, can be formed. In an embodiment, the forming hydrocarbon-based polymer film can possess optical properties such as a refractive index (n) of 1.6 or higher (preferably 1.75 or 1.80 or higher) and an extinction coefficient (k) of 0.1 or lower (preferably 0.05 or lower) for light at a wavelength of 633 nm. Furthermore, in an embodiment, the mechanical strength may be increased by 10% relative to a film formed by the same methods without the treatment described herein. Due to the high density, low extinction coefficient and high film stability of the forming hydrocarbon-based film, etching selectivity and alignment performance can be significantly improved.

In one embodiment, the active plasma treatment is part of a continuous film formation at a significantly low deposition rate that decreases with time using an inert gas plasma. At least in an embodiment, due to the continuous changes of plasma density with time (e.g., continuous decreases of the flow ratio of hydrocarbon gas to inert gas with time), the chemical structures or compositions of the film being deposited during the active plasma treatment are altered and vary in a film growth or thickness direction. Without being limited by theory, it is believed that as a result, the formation of dangling bonds can effectively be suppressed, and the diffusion of H₂ molecules to the surface can effectively be blocked. The surface of the resultant film inhibits water condensation, thereby significantly improving film stability and reliability. Further, at least in an embodiment, due to the continuous film formation, sudden changes in properties at the boundary can be minimized. Also, at least in an embodiment, due to the short duration of the active plasma treatment, the film formed during the active plasma treatment may not alter the nature of the principal film properties.

In an embodiment, a “hydrocarbon-based” polymer film may refer to a polymer film derived from a hydrocarbon precursor material. In an embodiment, a hydrocarbon-based polymer may refer to a polymer film constituted substantially by hydrocarbon. In an embodiment, a hydrocarbon-based polymer film is referred to as an organic carbon polymer film. In an embodiment, the hydrocarbon-based polymer film is referred to as a nano-carbon polymer (NCP) film or simply a carbon polymer film. In an embodiment, the hydrocarbon-based polymer film may be doped with N, O, and/or F, etc.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not to scale.

FIG. 1 is a schematic view showing an example of a CVD apparatus which can be used in an embodiment of the present invention.

FIG. 2 depicts a deposition recipe for forming a hydrocarbon-based polymer film according to an embodiment of the present invention.

FIG. 3 is a graph showing an example of the relationship between film stress and elapsed time for hydrocarbon-based polymer films according to an embodiment of the present invention and for comparative examples.

FIG. 4 is a graph showing an example of the relationship between film optical properties and elapsed time for hydrocarbon-based polymer films according to an embodiment of the present invention and for comparative examples.

FIG. 5 is a graph showing mechanical properties of hydrocarbon-based polymer films obtained according to an embodiment of the present invention and of comparative examples.

### DETAILED DESCRIPTION

Embodiments of the present invention will be explained below; however, the embodiments are not intended to limit the present invention.

An embodiment provides a method of forming a surface-treated hydrocarbon-based polymer film on a substrate by plasma CVD, comprising: (i) supplying a hydrocarbon gas as a source gas, and an inert gas, and applying RF power to generate a plasma and form a hydrocarbon-based principal film on a substrate; and (ii) continuously from step (i) without extinguishing the plasma, changing flow of the hydrocarbon gas and the inert gas by continuously decreasing a flow ratio of the hydrocarbon gas to the inert gas over time to treat a surface of the principal film on the substrate.

Embodiments include, but are not limited to, the following:

In an embodiment, the decreasing of the flow ratio may be performed by continuously increasing a flow rate of the inert gas with time. In an embodiment, the decreasing of the flow ratio may be performed by continuously decreasing a flow rate of the hydrocarbon gas with time.

In an embodiment, the decreasing of the flow ratio may be conducted by continuously increasing a flow rate of the inert gas while continuously decreasing a flow rate of the hydrocarbon gas with time. In an embodiment, the flow rate of the hydrocarbon gas may be continuously decreased to zero at the end of step (ii). In an embodiment, the flow ratio may decrease at a rate slower in the beginning of step (ii) than at the end of step (ii) (e.g., nearly decreases exponentially with time).

In any of the foregoing embodiments, step (i) may be continued until the principal film has a thickness of 100 nm to 1,000 nm, and step (ii) may be continued until the thickness is increased by 1 nm to 10 nm.

In any of the foregoing embodiment, step (i) and step (ii) may be conducted under common conditions except for the flow ratio of the hydrocarbon gas to the inert gas.

In any of the foregoing embodiments, the hydrocarbon gas may be a vapor phase of a hydrocarbon liquid monomer of C_{α}H_{β}, wherein α and β are natural numbers of 5 or more, with a boiling point of about 20° C. to about 350° C. In an embodiment, the hydrocarbon liquid monomer may have a benzene ring. In an embodiment, the only hydrocarbon precursor employed in the hydrocarbon gas is vaporized benzene liquid monomer. In an embodiment, the liquid monomer may have a carbon/hydrogen ratio (C/H) of 0.5 or higher (in another embodiment, the C/H ratio may be 0.4 or higher). In an embodiment, the hydrocarbon gas may be mesitylene. In an embodiment, the hydrocarbon gas may be a mixture of two or more of different hydrocarbon gases. In an embodiment, the hydrocarbon gas contains only hydrogen and carbon. As the liquid monomer, those disclosed in U.S. patent application Ser. No. 11/853,273, filed Sep. 11, 2007, which is owned by the same assignee as in the present application can be used in an embodiment, the disclosure of which is incorporated herein by reference in its entirety for the disclosure of liquid monomers.

In another embodiment, as the liquid organic monomer, a monomer containing no unsaturated carbon bonds can be used. In an embodiment, the liquid organic monomer consists of hydrocarbon and contains none of O, Si, F, and N in the monomer. In an embodiment, the source gas is exclusively the liquid organic monomer. In an embodiment, in addition to the liquid organic monomer, an inert gas and/or an additive gas are/is used as part of the hydrocarbon gas.

Since most of monomers having high molecular weights have low vapor pressures and are liquid at room temperature, they are vaporized in order to introduce them into a reaction chamber. In an embodiment of the present invention, use of liquid monomers is facilitated by using a vaporizer for vaporizing the liquid monomers, and heating and keeping a given temperature gas piping extending from the vaporizer to a reactor and a shower plate inside a reaction space, thus inhibiting monomers from re-condensation.

In any of the foregoing embodiments, the hydrocarbon gas may be the only source gas.

In any of the foregoing embodiments, the inert gas may be Ar, He, Ne, Kr, and/or N₂.

In any of the foregoing embodiments, the hydrocarbon-based polymer film may be transparent.

In any of the foregoing embodiments, the substrate subjected to step (i) may have a low-k film formed on its surface, and the hydrocarbon-based polymer film may be formed on the low-k film as a hard mask. Further, according to an embodiment, after being introduced into the reaction chamber, the liquid monomers are polymerized by a polymerization reaction by plasma to make it possible to form an organic carbon polymer film on a substrate surface, and it becomes possible to use the film formed as a hard mask for semiconductor processing, and is thus more durable than photoresist to survive the processes (e.g., etching) conducted with the mask in place. A carbon polymer film formed by plasma CVD has excellent characteristics as an optical film because it facilitates forming a thin film having transparency. Furthermore, the film optical property and the film stress is stable even when it is been exposed to the clean room atmosphere.

In a method of forming a hydrocarbon-based polymer film on a semiconductor substrate using a capacitively-coupled plasma CVD apparatus, the disclosed embodiments include a method which comprises: (i) vaporizing a hydrocarbon-containing liquid monomer (C_{α}H_{β}, wherein α and β are natural numbers of 5 or more); having a boiling point of about 15° C. to about 350° C., said liquid monomer being either unsaturated and or having benzene structure; (ii) introducing said vaporized gas into a CVD reaction chamber inside which a substrate is placed; and (iii) forming a hydrocarbon-based polymer film on said substrate by plasma polymerization of said gas. The substrate is, for example, a semiconductor device substrate with partially fabricated integrated circuits thereon.

In any of the aforesaid embodiments, as an additive gas, an organic gas CₙHₘ (wherein n is an integer of 4 or less including zero; m is any natural number) may further be introduced into the reaction chamber. In any of the aforesaid embodiments, as an additive gas, a dry gas containing any one or two or all of N, O, and F may further be introduced into the reaction chamber.

Additionally, according to another embodiment, a method of forming a hydrocarbon-based polymer film on a semiconductor substrate using a capacitively-coupled plasma CVD apparatus, comprises the steps of placing a semiconductor device substrate inside a CVD reaction chamber, vaporizing a hydrocarbon-containing liquid monomer (C_{α}H_{β}, wherein α and β are natural numbers of 5 or more) having a boiling point of 15° C. to 350° C. (which may or may not be substituted by a vinyl group or an acetylene group), introducing the vaporized gas into the CVD reaction chamber inside which the substrate is placed, and forming a hard mask composed of a hydrocarbon-based polymer film on the substrate by plasma polymerizing the gas.

In any of the foregoing embodiments, the liquid monomer may be introduced into a vaporizer disposed upstream of the reaction chamber and vaporized. Additionally, the liquid monomer may be flow-controlled by a valve upstream of the vaporizer, and introduction of the liquid monomer into the vaporizer may be blocked by a shutoff valve disposed between the flow control valve and the vaporizer and kept at 200° C. or lower or at a temperature lower than that of vaporization by approximately 150° C. or more except during deposition when a polymerized material is formed. Or, the liquid monomer may be flow-controlled by a valve disposed upstream of the vaporizer and kept at 200° C. or lower or at a temperature lower than that of vaporization by approximately 150° C. or more, and at the same time introduction of the liquid monomer into the vaporizer may be blocked except during deposition when a polymerized material is formed.

Also in embodiments using any one of the above-mentioned valves, the liquid monomer may be mixed with an inert gas downstream of the valve and upstream of the vaporizer.

Embodiments will be explained with reference to the drawings which are not intended to limit the present invention.

Film Formation Sequences

To deposit a hydrocarbon-based polymer layer on a 300-mm wafer, a hydrocarbon gas source such as mesitylene and an inert gas such as He are introduced into a reaction zone.

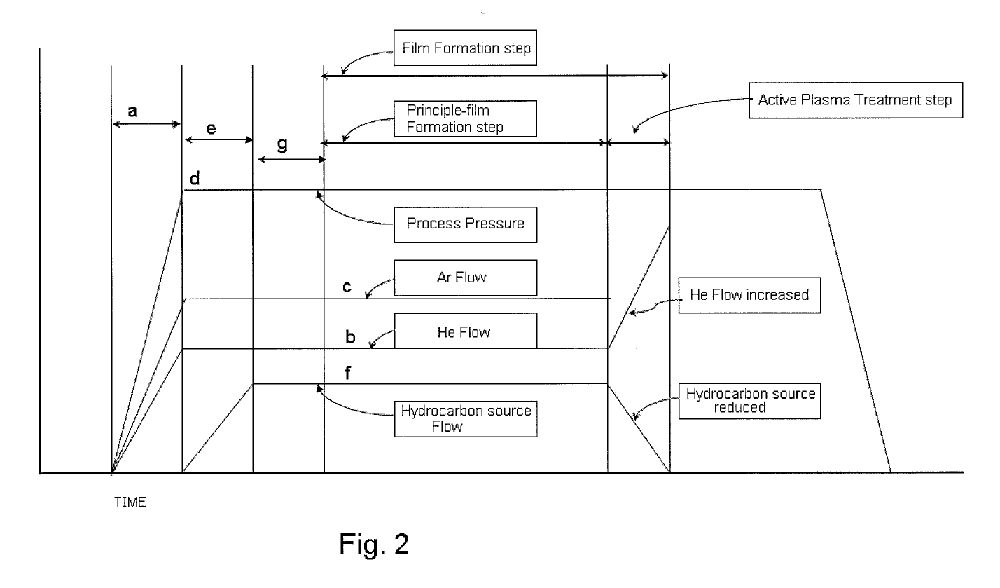

FIG. 2 illustrates an embodiment of the present invention. After a semiconductor substrate is carried into a reaction chamber and is heated at a given temperature, in the step (a), helium (b) and argon (c), each of which is an inert gas, are brought into the reaction chamber at a predetermined flow within the range of 100 sccm to 3000 sccm, and the pressure (d) inside the reaction chamber is controlled at a predetermined value within the range of 100 Pa to 1000 Pa. In step (e), a hydrocarbon precursor or source gas in the form of mesitylene (f) is brought into the reaction chamber at a predetermined flow within the range of 50 sccm to 500 sccm. For introducing the hydrocarbon source gas and He and Ar, a linear increasing method in which a flow of respective gases is increased from zero to a given value at a specific rate during predetermined time frames is adopted. This method is used to prevent floating of particles in the reaction chamber and adhering of the particles to the semiconductor substrate. Such a phenomenon is caused by a sudden pressure rise in the reaction chamber resulting from a drastic gas flow change into the reaction chamber.

Once the gas flow such as mesitylene (f) and He (b) is stabilized as shown in step (g), RF power with a frequency of 13.56 MHz is applied in the range of 100 W to 3000 W, and a principal-film formation step begins, wherein a hydrocarbon-based polymer is formed.

The hydrocarbon-based polymer film deposition (film formation step) is divided into 2 steps. First, a principal film is formed on the substrate by using mesitylene and He and applying RF power as shown in FIG. 2 (e.g., mesitylene=300 sccm; He=400 sccm; Ar=2000 sccm; 13.56 MHz at 1800 W; substrate temperature=340° C.; chamber pressure=500 Pa).

Second, an active plasma treatment is performed. After the principal film formation step, the second film formation is carried out. In this step, He flow is increased while hydrocarbon source gas flow, such as mesitylene flow, is decreased without changing plasma discharge (i.e., without extinguishing the plasma). On the other hand, argon flow in this recipe is stopped during the active plasma treatment step. However, since Ar is another inert gas, it can be either kept continuously flowing, increased or reduced depending on the process requirement. The film formation is continued, typically at a reduced rate due to decreasing relative hydrocarbon source gas flow, during the active plasma treatment step.

The hydrocarbon-based polymer film deposited by the principal film forming step alone is not stable, and its film stress and extinction coefficient tend to drift when being exposed to air at room temperature, such as exposure to the clean room environment. This is due to the oxidation of the surface layer. A method of minimizing the oxidation of carbon containing films, such as SiC, is published in United States Patent Application Publication 2002/054962. However, no changes/improvements to the film properties were observed after applying comparable methods to hydrocarbon-based polymer films (see Example 2 below). Furthermore, when annealing is performed at 400° C. under a nitrogen atmosphere for 10 hours, a drastic change in the film stress is observed. The change in the stress is about 400 MPa, which is considered to represent poor thermal stress stability behavior.

When the active plasma treatment in an embodiment of this invention is performed on the hydrocarbon-based polymer films, such as the process described with respect to FIG. 2, the unstable phenomena of the film stress and extinction coefficient can be resolved. Also the mechanical properties are improved, indicating that the films according to an embodiment of the present invention exhibit better strength performance and are likely to improve current selectivity performance during semiconductor processing, such as etching or CMP.

In FIG. 2, during the active plasma treatment step, the inert gas flow increases linearly, whereas the hydrocarbon gas flow decreases linearly to zero. By doing this, the ratio of hydrocarbon gas to inert gas decreases at a smaller rate in the beginning of the active plasma treatment step than at the end (i.e., the ratio nearly exponentially decreases with time). Due to the gradual or slow change of film formation conditions in the beginning of the active plasma treatment step, sudden changes in properties at the boundary can be minimized.

In an embodiment, the active plasma treatment is a continuous film formation at a significantly low deposition rate decreasing over time using an inert gas plasma. Due to the continuous changes of plasma density over time (e.g., continuous decreases of the flow ratio of hydrocarbon gas to inert gas over time), the chemical structures or compositions of the film depositing during the active plasma treatment are altered and vary in a film growth or thickness direction, and it is believed that, as a result, the formation of dangling bonds can effectively be suppressed, and the diffusion of H₂ molecules to the surface can effectively be blocked. The surface of the resultant film inhibits water condensation, thereby significantly improving film stability and reliability. Also, due to the short duration of and reducing deposition rate during the active plasma treatment, the film formed during the active plasma treatment may not alter the nature of the principal film properties.

In some embodiments, the principal film formation step and the active plasma treatment step may be performed as follows:

The principal film formation step:

Thickness of film: 100-1000 nm

Duration: 10-100 sec.

Deposition rate: 100-1000 nm/min

The active plasma treatment step:

Thickness of film: 1-10 nm

Duration: 0.1-60 sec.

Deposition rate: 0.1-10 nm/min

In another recipe, although the hydrocarbon gas flow decreases, it does not reach zero at the end of the active plasma treatment step. In still another recipe, the hydrocarbon gas flow is constant whereas the inert gas flow increases. In yet another recipe, the hydrocarbon gas flow decreases whereas the inert gas flow is constant. In the above, any changes of gas flow can be performed linearly or in a curved manner, or in a plurality of steps.

Apparatus Configuration

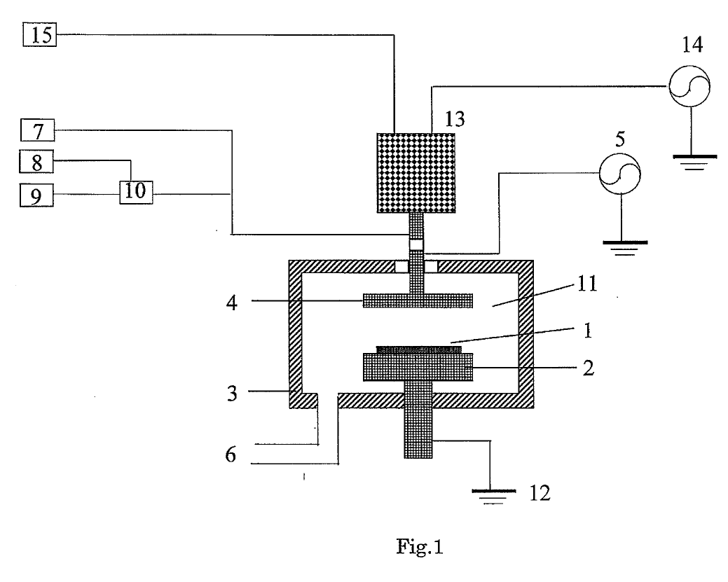

FIG. 1 is a schematic view of an apparatus combining a vaporizer and a plasma CVD reactor, which can be used in an embodiment of the present invention. An apparatus which can be used in the present invention is not limited to the example shown in FIG. 1. Any suitable apparatus can be used.

In this example, by providing a pair of electrically conductive flat-plate electrodes 4, 2 in parallel and facing each other inside a reaction chamber 11, applying RF power 5 to one side, and electrically grounding 12 the other side, plasma is excited between the electrodes. A temperature regulator is provided in a lower stage 2, which serves as the grounded electrode in the example, and temperature is kept constantly at a given temperature in the range of 0° C.-650° C. to regulate a temperature of a substrate 1 placed thereon. An upper electrode 4 serves as a shower plate as well, and reaction gas is introduced and distributed into the reaction chamber 11 through the shower plate. Additionally, in the reaction chamber 11, an exhaust pipe 6 is provided through which gas inside the reaction chamber 11 is exhausted. Further, numeral 13 refers to a remote plasma unit, numerals 14 and 15 refer to a remote plasma power source and a gas flow mass control unit, respectively.

A vaporizer 10 that vaporizes a liquid organic monomer has an inlet port for a liquid and an inlet port for an inert gas in an embodiment and comprises a mixing unit for mixing these gases and a unit for heating and/or cooling the mixture. In the embodiment shown in FIG. 1, an inert gas is introduced from an inert gas flow-controller 8 to the vaporizer 10; and a liquid monomer is introduced from a liquid monomer flow-controller 9 into the vaporizer 10. Storage/processing temperature for the mixture is determined by a vapor pressure characteristic of the liquid monomer; in an embodiment, the temperature is kept in the range of 0° C.-350° C. (e.g., 15° C.-350° C.). Vaporized gas is introduced into the reactor through gas piping. Additionally, the embodiment shown in FIG. 1 is designed to be able to introduce an additive gas including an inert gas from a gas flow-controller 7 into the reactor. Additionally, an inert gas can also be introduced into the reactor without passing through the vaporizer 10. The number of gas flow-controllers can be provided appropriately to meet the number of gas types used.

The piping introducing the gas from the vaporizer to the reactor and a showerhead unit in an upper portion of the reactor are temperature-controlled at a given temperature in the range of 15° C.-350° C. by a vaporizer and their outer side is covered by an insulating material.

Liquid Organic Monomer

In an embodiment, the liquid organic monomer that provides the source gas can comprise a hydrocarbon-containing liquid monomer (C_{α}H_{β}, wherein α and β are natural numbers of 5 or more) having a boiling point of room temperature or higher (e.g., 15° C.-350° C.), which may or may not have a substituent vinyl group or acetylene group. Preferably, the carbon number is 5-30; in an embodiment, the carbon number is 5-12. Additionally, a boiling point is preferably approximately 15° C. to approximately 350° C.; in another embodiment, it is approximately 15° C. to approximately 200° C.; and in still another embodiment, it is approximately 15° C. to approximately 100° C. or higher. The liquid monomer is a cyclic hydrocarbon in an embodiment. The cyclic hydrocarbon can be a benzene or benzene derivative.

The liquid monomer may have a benzene structure, such as mesitylene. In another embodiment, the liquid monomer may be non-cyclic or without a benzene structure, such as C₅H₈. As the liquid monomer, a single species or two or more species in various combinations can be used. In any of the foregoing embodiments, the liquid monomer may have a carbon and hydrogen ratio of 0.45 or higher, preferably 0.5 or higher.

When the carbon/hydrogen ratio is high, the carbon content in ions or radicals generated by a plasma becomes high, thereby increasing the density of the forming polymer film which can serve as a carbon hard mask. For example, by using C₉H₁₂ (α=9, β=12, C/H=0.75) instead of C₅H₁₂ (α=5, β=12, C/H=0.416), an extinction coefficient (k) of the forming polymer film for light having a wave length of 633 nm can be controlled from 0.005 to 0.1, and a refractive index (n) of the forming polymer film can be controlled from 1.6 to 1.9. This may be because when the liquid monomer having a high C/H ratio is exposed to plasma, the state having a high C/H ratio can be maintained while forming a film, thereby increasing density. Furthermore, the extinction coefficient decreases because it is strongly dependent on the deposition temperature. This maybe because when the temperature is reduced the film bonding structure is changed. More specifically, when reducing temperature more diamond-like (sp3) bonds are formed, which influences the extinction coefficient. On the other hand when the temperature is increased more pure graphite-like (sp2) is developed, which degrades the optical performances as a hard mask. Due to the high density and low extinction coefficient of the film, the etching selectivity and alignment performance can be improved.

Additionally, in another embodiment, a liquid organic monomer is a hydrocarbon-containing liquid monomer (C_{α}H_{β}, wherein α and β are natural numbers of 5 or more) having a boiling point of room temperature or higher (e.g., approximately 15° C.-approximately 350° C.). Using this monomer, a hard mask is formed. Preferably, the carbon number is 5-30; the carbon number is 5-12 in an embodiment. A boiling point is preferably approximately 15° C. to approximately 350° C.; it is approximately 15° C. to approximately 200° C. in an embodiment. In an embodiment, the liquid monomer is cyclic hydrocarbon. Additionally, in an embodiment, the liquid monomer is a combination of two types or more of non-substituted benzene.

Additionally, it may be linear hydrocarbon; the linear hydrocarbon may be pentane, iso-pentane, neo-pentane, hexane, 1-pentene, 1-hexene, or 1-pentyne.

In an embodiment, the hydrocarbon monomer containing at least one unsaturated carbon bond is CₙH₂₍ₙ₋ₘ₎₊₂ (n is a natural number of 5 or greater, m is a natural number of 1 or greater but smaller than n). In an embodiment, a liquid material containing the liquid monomer with unsaturated carbon further contains 10 ppm to 1,000 ppm (e.g., 100 ppm to 600 ppm) of an inhibiter consisting of C, H and O such as t-butylcatechol, 2,6-di-tert-butyl-4-methylphenol, and dibutylhydroxytoluene (BHT), in order to inhibit the liquid monomer from being polymerized in a tank and/or pipes upstream of the reaction chamber. In still another embodiment, two or more hydrocarbon monomers containing at least one unsaturated carbon bond, each being expressed as CₙH₂₍ₙ₋ₘ₎₊₂ (n is a natural number of 5 or greater, m is a natural number of 1 or greater but smaller than n), can be used in combination. In an embodiment, the liquid monomer can be a mixture of at least one cyclic hydrocarbon-containing compound such as those explained in this disclosure and at least one non-cyclic hydrocarbon-containing compound such as those explained in this disclosure.

In the above, examples include but are not limited to cyclopentane, C₅H₁₀, having a boiling temperature of 49° C., isoprene (2-methyl-1,3-butadiene), CH₂═C(CH₃)CH═CH₂ (i.e., C₅H₈), having a boiling temperature of 35° C. and cyclopentene, C₅H₈, having a boiling temperature of 46° C. Further, any one of organic monomers selected from the group consisting of 3-methyl-1,2-butadiene, 1,4-dimethyl-1,3-butadiene, and 1,2-dimethyl-1,3-butadiene, can be used as a source gas.

The details of the process parameters and film forming are explained below.

Hydrocarbon-Based Polymer Film Formation

As an exemplary process for growing a hydrocarbon-based polymer film on a substrate according to an embodiment of the present invention, the parameters listed in Tables 1 through 3 can be used:

TABLE 1

| | Range | |
|---|---|---|
| | Basic film | Active Plasma |
| Parameters | forming Step | Treatment Step |
| Mesitylene | 1 sccm~1000 sccm | 0 sccm~100 sccm |
| He | 100 sccm~10000 sccm | 100 sccm~10000 sccm |
| Ar | 100 sccm~10000 sccm | 100 sccm~10000 sccm |
| Process Pressure | 100 Pa~1000 Pa | 100 Pa~1000 Pa |
| HRF Power | 100 W~3000 W | 100 W~3000 W |
| Substrate Temperature | 200° C.~600° C. | 200° C.~600° C. |
| Electrode spacing | 1-30 mm | 1-30 mm |

TABLE 2

| | Preferred Range | |
|---|---|---|
| | Basic film | Active Plasma |
| Parameters | forming Step | Treatment Step |
| Mesitylene | 10 sccm~500 sccm | 0 sccm~75 sccm |
| He | 100 sccm~7500 sccm | 100 sccm~75000 sccm |
| Ar | 100 sccm~7500 sccm | 100 sccm~7500 sccm |
| Process Pressure | 100 Pa~1000 Pa | 100 Pa~1000 Pa |
| HRF Power | 100 W~300 W | 100 W~3000 W |
| Substrate Temperature | 200° C.~400° C. | 200° C.~400° C. |
| Electrode spacing | 5-25 mm | 5-25 mm |

TABLE 3

| | Most Preferred Range | |
|---|---|---|
| | Basic film | Active Plasma |
| Parameters | forming Step | Treatment Step |
| Mesitylene | 20 sccm~200 sccm | 0 sccm~50 sccm |
| He | 100 sccm~5000 sccm | 100 sccm~5000 sccm |
| Ar | 100 sccm~5000 sccm | 100 sccm~5000 sccm |
| Process Pressure | 200 Pa~800 Pa | 200 Pa~800 Pa |
| HRF Power | 500 W~2500 W | 500 W~2500 W |
| Substrate Temperature | 300° C.~400° C. | 300° C.~400° C. |
| Electrode spacing | 7-25 mm | 7-25 mm |

Flow Rate and Other Conditions

A flow rate of the liquid monomer is not particularly restricted, but as a flow rate introduced into a reaction chamber after vaporization, in an embodiment, it is approximately 30 sccm to approximately 1000 sccm (50 sccm, 100 sccm, 150 sccm, 200 sccm, 300 sccm, 400 sccm, 500 sccm, and including a range defined by any one of foregoing values).

Additionally, an inert gas can be introduced into a reaction chamber. For example, the inert gas can be one of or a combination of two or more of Ar, He, Ne, Kr, Xe, and N₂; preferably Ar and/or He. A flow rate of an inert gas introduced into a reaction chamber is approximately 0 sccm to approximately 10000 sccm (30 sccm, 50 sccm, 100 sccm, 150 sccm, 200 sccm, 300 sccm, 500 sccm, 1000 sccm, 2000 sccm, 3000 sccm and including a range defined by any one of foregoing values).

In an embodiment, the hydrocarbon-based polymer film deposition step is divided into 2 steps. First, a principal film is formed on the substrate by introducing the hydrocarbon source and inert gas at an equilibrium pressure and applying RF power.

Second, an active plasma treatment step is performed. After the principal film formation step, second film formation is carried out continuously. In this step, inert gas flow is increased while hydrocarbon source is decreased without changing plasma discharge. The film formation is continued during the active plasma treatment.

Additionally, in an embodiment, further as an additive gas, an organic gas CₙHₘ (wherein n is an integer of 4 or less including zero; m is any natural number) can also be introduced into a reaction chamber. Or, further as an additive gas, a dry gas containing any one or more or all of N, O, and F can also be introduced into a reaction chamber. Additionally, as a reducing gas, hydrogen, ammonia, carbon monoxide, etc. can also be used as an additive gas. A flow rate of an additive gas introduced into a reaction chamber is approximately 0 sccm to approximately 300 sccm (30 sccm, 50 sccm, 100 sccm, 150 sccm, 200 sccm, and including a range defined by any one of foregoing values). In an embodiment where the liquid monomer is a non-benzene monomer, a flow rate of an additive gas introduced into a reaction chamber is approximately 0 sccm to approximately 600 sccm (30 sccm, 50 sccm, 100 sccm, 150 sccm, 200 sccm, 500 sccm, and including a range defined by any one of foregoing values).

Consequently, in an embodiment, an organic carbon polymer film is formed using only a hydrocarbon-containing monomer and an inert gas. Or the film may be formed using only a hydrocarbon-containing monomer. Additionally, only a hydrocarbon-containing monomer and an inert gas, or a hydrocarbon-containing gas, an inert gas and an additive gas can be used. Additionally, in an embodiment, a flow rate of a gas other than a hydrocarbon-containing monomer is less than that of the hydrocarbon-containing monomer (gaseous), preferably less than a half that of the hydrocarbon-containing monomer (gaseous). In an embodiment such that where the liquid monomer is a non-benzene monomer, a flow rate of a gas other than a hydrocarbon-containing monomer is more than that of the hydrocarbon-containing monomer (gaseous), preferably about 10 times that of the hydrocarbon-containing monomer (gaseous).

Additionally, in an embodiment in which an inert gas is mixed in a vaporizer, the inert gas may be introduced into a reaction chamber. The above-mentioned description of inert gas to be introduced into the reaction chamber can apply to the inert gas of the present example. In this case, in substitution for an inert gas introduced directly into the reaction chamber, an inert gas can be introduced through a vaporizer. Additionally, an inert gas introduced directly into the reaction chamber and an inert gas introduced through the vaporizer can also be used together. In an embodiment, a flow rate of an inert gas introduced through the vaporizer is equal to or more than that of an inert gas introduced directly. Additionally, in an embodiment, the same type of inert gas is used for the one introduced through the vaporizer and the one introduced through the vaporizer; in another embodiment, different types of inert gases are used.

Plasma polymerization can be performed in an embodiment under the conditions: a substrate temperature of approximately 0° C. to approximately 600° C. (including a range of 150° C.-450° C. and a range of 250° C.-400° C.), a reaction pressure of approximately 10 Pa to approximately 1500 Pa (including a range of 50-1000 Pa, a range of 100-900 Pa, and a range of 400-800 Pa in embodiments). In preferred embodiments, the temperature (measured as the susceptor temperature) may be 400° C. or less, more preferably 350 ° C.

As to RF power density, a plasma polymerization step is performed under the conditions of: RF power density of approximately 0.01 W/cm² to approximately 20 W/cm² (per substrate area) (including a range of 0.05-10 W/cm², a range of 1-5 W/cm2, and a range of 0.5-5 W/cm² in embodiments).

Power per unit monomer is changed under various other conditions; a plasma polymerization step can be performed under the condition of 0.01-100 W/sccm (including a range of 0.05-50 W/sccm and a range of 3-20 W/sccm) in an embodiment; RF power can also be controlled per monomer unit flow rate. In another embodiment, such as where the liquid monomer is a benzene monomer, a plasma polymerization step can be performed under the condition of 0.01-500 W/sccm (including a range of 1-100 W/sccm and a range of 3-50 W/sccm) in an embodiment.

Additionally, a plasma polymerization step can be performed using a frequency exceeding 5 MHz, e.g., any one of high RF (HRF) power of 13.56 MHz, 27 MHz or 60 MHz, in an embodiment; further, one of the foregoing high RF power and low RF (LRF) power of 5 MHz or less (including 2 MHz or less and 500 kHz or less) can be combined. In an embodiment, a ratio of low RF power is 50% or less, 30% or less, or 10% or less of high RF power.

A thickness of an organic polymer can be appropriately selected according to intended uses. In an embodiment, it is 50-1500 nm or 100-1000 nm.

When films are formed using liquid monomers having a C/H ratio of 0.5 or higher, having benzene rings, the films can show significantly improved properties in terms of all of refractive index (n), extinction coefficient (k), density, modulus, and hardness. In embodiments, the films may have a refractive index (n) of 1.6 or higher (e.g., 1.60-2.00), a extinction coefficient (k) of 0.10 or lower (e.g., 0.001-0.05), a density of 1.30 or higher (e.g. 1.30-1.48), a modulus of 20 GPa or higher (e.g., 30-60 GPa), and a hardness of 4 or higher (e.g., 5-10 GPa).

Reactor Cleaning and After-Treatment

Additionally, after film formation on a substrate is completed, cleaning inner walls of a reaction chamber is desirable. For example, cleaning of a wall surface of the reaction chamber can be performed by introducing oxygen (O₂) and/or a mixture gas of CₓF_{y} (x and y are any natural numbers respectively) and an inert gas into the reaction chamber and generating plasma between electrodes; after film formation on a substrate is completed, cleaning of a wall surface of the reaction chamber can be performed by introducing a gas containing radical molecules containing O and/or F into the reaction chamber; or after film formation on a substrate is completed, cleaning of a wall surface of the reaction chamber can be performed by introducing a gas containing radical molecules containing O and/or F into a reaction chamber, generating plasma between electrodes.

Additionally, during the process of cleaning a wall surface of the reaction chamber using fluorine based gas chemistry technique, fluorine based residue is likely to be generated on the wall surface of the reaction chamber. These unwanted residues can be removed by introducing a reduction gas and reduction radical molecules into the reaction chamber and generating plasma between electrodes.

Further, in order to improve mechanical strength of a film, heat curing of the film formed can be performed by combining ultraviolet (UV) and electron beam (EB).

In the present disclosure where conditions and/or structures are not specified, the skilled artisan in the art can readily provide such conditions and/or structures, in view of the present disclosure, as a matter of routine experimentation.

Also, in the present disclosure, the numerical numbers applied in embodiments can be modified by ±50% in other embodiments, and the ranges applied in embodiments may include or exclude the endpoints.

Experimental Result

Examples of the disclosed embodiments are explained below, but the present invention is not limited to these examples.

Common conditions: Common conditions in respective examples are as follows: Eagle®-12 (commercially available from ASM Japan of Tokyo, Japan) possessing a basic structure shown in FIG. 1 was used as a reactor. Additionally, although a liquid monomer was flow-controlled by a flow control unit in a liquid phase, an amount of gas introduced into a reactor was obtained by molar conversion from the flow rate of the liquid.

Reactor Settings

Temperature of upper electrode (shower plate): 180° C.

Temperature of reactor wall: 180° C.

Size of shower plate: φ325 mm (Size of substrate: 4300 mm)

Gap between shower plate and susceptor: 16 mm

The temperature of the vaporizer and that of the piping were selected based on the boiling point, the vaporizing pressure, etc. of the precursor used.

### EXAMPLE 1

Process conditions in this example and film formation results are shown as follows:

Process Parameter and Set Points:

| | Principal film |
|---|---|
| Parameters | forming Step |
| Mesitylene | 120 sccm |
| He | 400 sccm |
| Ar | 2000 sccm |
| Process Pressure | 500 Pa |
| HRF Power | 1800 W |
| Substrate Temperature | 340° C. |
| Electrode spacing | 16 mm |
| Process time | 18.5 sec. |

He supplied to vaporizer: 500 sccm

Temperature of vaporizer, vaporizer portion: 150° C.

Controlled temperature of gas inlet piping: 150° C.

Film Formation Results:

Thickness: 22 4 nm

RI(n)@633 nm: 1.83

Extinction coefficient (k) @633 nm: 0.05

Film Stress: −174 MPa

Modulus: 33.35 GPa

Hardness: 4.57 GPa

Density: 1.29 g/cm³

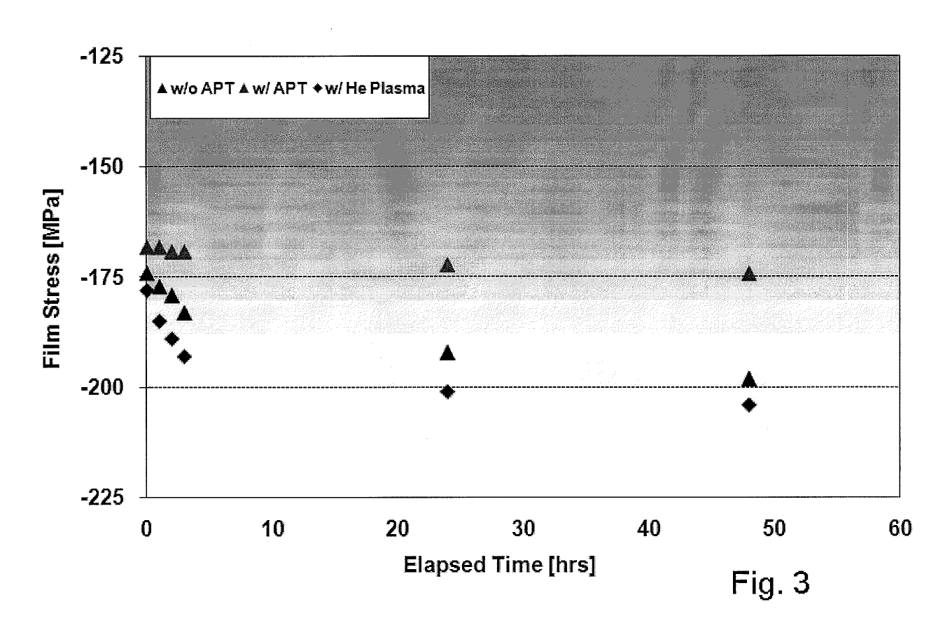

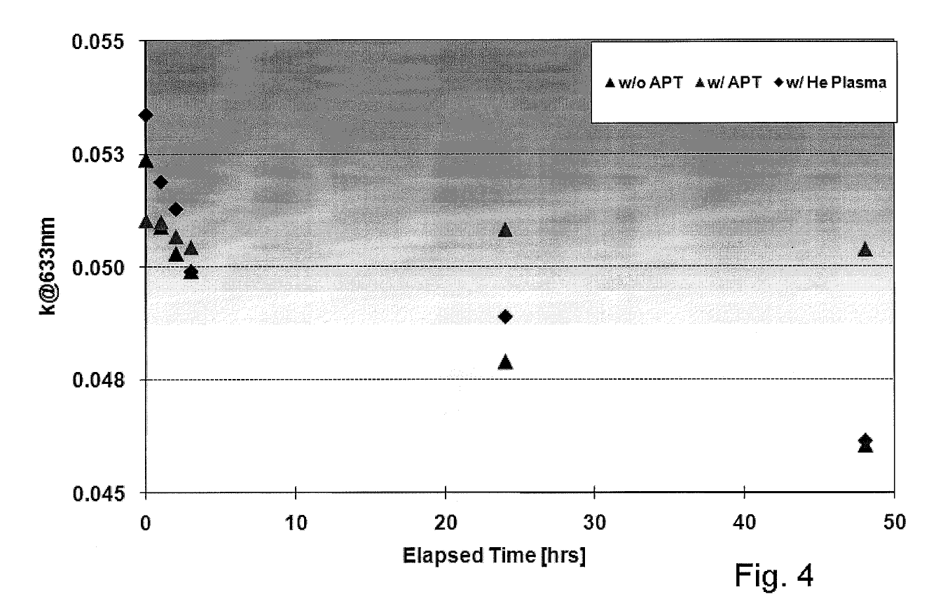

The film formed using above conditions (Example 1) shows fairly good film properties. However, it has a poor film stability performance. FIG. 3 is a graph showing the relationship between film stress and elapsed time of the hydrocarbon-based polymer film obtained above (“w/o APT”). FIG. 4 is a graph showing the relationship between film optical properties and elapsed time of the hydrocarbon-based polymer film obtained above (“w/o APT”). The elapsed time is a time period for which the film was exposed to an environment in a clean room. As shown in FIGS. 3 and 4, both film stress and optical properties of the film started significant degradation immediately after the film was deposited.

### EXAMPLE 2

Process conditions in this example were the same as in Example 1 except that a He plasma treatment step was implemented after the principal film formation step.

Process Parameter and Set Points:

| | Principal film | He Plasma |
|---|---|---|
| Parameters | forming Step | Treatment |
| Mesitylene | 120 sccm | 0 sccm |
| He | 400 sccm | 2.5 slm |
| Ar | 2000 sccm | 0 sccm (No flow) |
| Process Pressure | 500 Pa | 500 Pa |
| HRF Power | 1800 W | 1800 W |
| Substrate Temperature | 340° C. | 340° C. |
| Electrode spacing | 16 mm | 16 mm |
| Process time | 18.5 sec. | 10 sec. |

Film Formation Results:

Thickness: 231 nm

RI(n) @ 633 nm: 1.82

RI(k) @ 633 nm: 0.05

Film Stress: −178 MPa

Modulus: 33.6 GPa

Hardness: 4.47 GPa

Density: 1.28 g/cm³

The film formed using the He plasma treatment shows fairly good film properties. However, as shown in FIGS. 3 and 4, the film obtained above (“w/ He Plasma”) has a unreliable film stability performance, and no improvements were observed as compared with the film of Example 1.

### EXAMPLE 3

Process conditions in this example were the same as in Example 1 except that an active plasma treatment step was implemented after the principal film formation step.

Process Parameter and Set Points:

| | Principal film | |
|---|---|---|
| Parameters | forming Step | Active Plasma Treatment |
| Mesitylene | 120 sccm | Linearly Reduced to 0 sccm |
| He | 400 sccm | Linearly Increased to 2.5 slm |
| Ar | 2000 sccm | 0 sccm (No flow) |
| Process Pressure | 500 Pa | 500 Pa |
| HRF Power | 1800 W | 1800 W |
| Substrate Temperature | 340° C. | 340° C. |
| Electrode spacing | 16 mm | 16 mm |
| Process time | 18.5 sec. | 10 sec. |

Film Formation Results:

Thickness: 231 nm (The thickness of the principal film: 223 nm; the active plasma treated film: 8 nm)

RI(n)@633 nm: 1.82

RI(k)@633 nm: 0.05

Film Stress −168 MPa

Modulus: 36.6 GPa

Hardness: 5.17 GPa

Density: 1.39 g/cm³

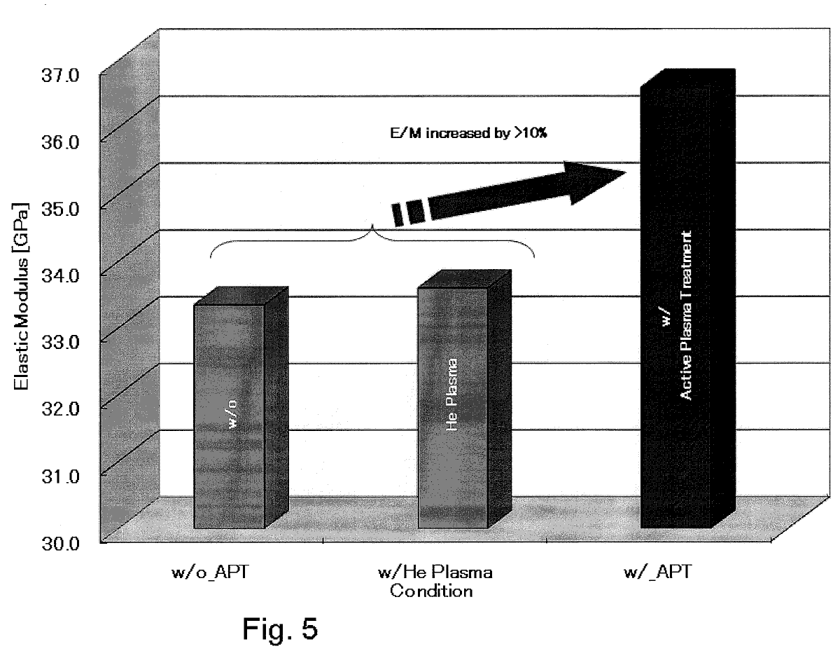

The film formed using the active plasma treatment step shows an excellent film property. As shown in FIG. 5, elastic modulus of the film of Example 3 (“w/ APT”) was improved by more than 10% as compared with the films of Example 1 (“w/o APT”) and Example 2 (“w/ He Plasma”). Furthermore, as shown in FIGS. 3 and 4, the film obtained above (“w/ APT”) has excellent stability and reliability. As compared with the films of Examples 1 and 2, the film of Example 3 shows surprisingly improved stability of the properties.

As shown above, according to embodiments, the extinction coefficient (k) of the forming polymer film for light of wave length 633 nm and the film stress can be kept stable even when the film is exposed to the clean room atmosphere. Further, due to stability of film stress, good adhesion behavior between a hydrocarbon-based polymer used as a hard mask and an underlying layer, specifically a layer to be patterned, is expected. Hardness and Elastic Modulus of the film deposited according to embodiments of the present invention may be above 4 GPa and above 30 GPa, respectively, which indicates that the hydrocarbon-based polymer films according to embodiments of the present invention are suitable to use as hard masks for patterning layers underneath. Furthermore due to the low extinction coefficient of the film, alignment performance can also be improved.

The present invention includes the above mentioned embodiments and other various embodiments including the following:

1) A method of forming a stable and reliable transparent hydrocarbon-based polymer film on a substrate by plasma CVD, comprising: (i) principal film formation, where the principal film is formed on the substrate by flowing hydrocarbon gas (C_{α}H_{β}, wherein α and β are natural numbers), an inert gas such as He and applying RF power; (ii) active plasma treatment, where after the principal film formation, a second film formation is carried out continuously, in which inert gas flow such as the He flow is either increased or reduced while hydrocarbon gas source is also either increased or reduced without changing plasma discharge.

2) The method of 1), wherein the active plasma treatment is a process of passivating the film formed on the surface of the substrate and has a film density higher than the film formed on the surface of the substrate.

3) The method of 1), wherein the film formation is continued during the active plasma treatment.

4) The method of 1), wherein the active plasma treatment comprises hydrogen-containing gas incorporating an inert gas.

5) The method of 1), wherein the He flow rate during active plasma treatment is increased from the rate during the principal film formation.

6) The method of 1), wherein the hydrocarbon gas source flow rate during active plasma is decreased from the rate during the principal film formation.

7) The method of 1), wherein the hydrocarbon gas source and inert gas such as He during the active plasma treatment is reduced and increased respectively without changing the plasma discharge.

8) The method of 1), wherein the duration period of step 2, which is stated here as active plasma treatment, is performed for more than 1 second.

9) The method of 1), wherein the hydrocarbon gas is a gaseous phase of a hydrocarbon liquid monomer (C_{α}H_{β}, wherein α and β are natural numbers of 5 or more) having a boiling point of about 20° C. to about 350° C.

10) The method of 1), wherein the processing temperature is above 100° C.

11) The method of 2), wherein the liquid monomer has a carbon/hydrogen ratio (C/H) of 0.5 or higher.

12) The method of 1), wherein the step of forming the hydrocarbon-based polymer film is conducted at a pressure of less than 1000 Pa.

13) The method of 1), wherein the flow ratio and the processing temperature are controlled, thereby forming the hydrocarbon-based polymer film having an extinction coefficient of less than 0.1 as measured for light of optical wavelength 633 nm.

14) The method of 1), wherein the inert gas is Ar, He, Ne, Kr, and/or N₂.

15) The method of 1), wherein the step of forming the hydrocarbon-based polymer film is conducted under at an RF power density of about 0.01 W/cm² to about 20 W/cm².

16) The method of 2), wherein the liquid monomer is cyclic.

17) The method of 15), wherein the liquid monomer is cyclopentane.

18) The method of 15), wherein the liquid monomer is cyclopentene.

19) The method of 15), wherein said liquid monomer is isoprene.

20) The method of 1), wherein the step of introducing the main gas further comprises introducing as an additive gas an organic gas CnHm (wherein n is an integer of 4 or less including zero; m is any natural number) into the reaction chamber.

21) The method of 1), wherein the principle film formation further comprises introducing as an additive gas a dry gas containing any one or more or all of N, O, and F is into the reaction chamber.

22) The method of 5), wherein the hydrocarbon-based polymer film has a density of more than 1.0 g/cm³.

23) The method of 5), wherein the hydrocarbon-based polymer film has a refractive index (n) of 1.6 or higher for light of optical wave length 633 nm.

24) The method of 1), wherein the hydrocarbon-based polymer film is formed on the substrate as a hard mask and used for patterning an underlying layer during the process of fabricating semiconductor devices.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A method of forming a surface-treated hydrocarbon-based polymer film on a substrate by plasma CVD, comprising:
(i) supplying a hydrocarbon gas as a source gas, and an inert gas, and applying RF power to generate a plasma and form a hydrocarbon-based principal film on a substrate; and
(ii) continuously from step (i) without extinguishing the plasma, changing flow of the hydrocarbon gas and the inert gas by continuously decreasing a flow ratio of the hydrocarbon gas to the inert gas over time to treat a surface of the principal film on the substrate.

2. The method according to claim 1, wherein the decreasing of the flow ratio is performed by continuously increasing a flow rate of the inert gas over time.

3. The method according to claim 1, wherein the decreasing of the flow ratio is performed by continuously decreasing a flow rate of the hydrocarbon gas over time.

4. The method according to claim 1, wherein the decreasing of the flow ratio is conducted by continuously increasing a flow rate of the inert gas while continuously decreasing a flow rate of the hydrocarbon gas over time.

5. The method according to claim 4, wherein the flow rate of the hydrocarbon gas is continuously decreased to zero at the end of step (ii).

6. The method according to claim 4, wherein the flow ratio decreases slower in the beginning of step (ii) than at the end of step (ii).

7. The method according to claim 1, wherein step (i) is continued until the principal film has a thickness of 100 nm to 1,000 nm, and step (ii) is continued until the thickness is increased by 1 nm to 10 nm.

8. The method according to claim 1, wherein step (i) and step (ii) are conducted under common conditions except for the flow ratio of the hydrocarbon gas to the inert gas.

9. The method according to claim 1, wherein the hydrocarbon gas is a gaseous phase of a hydrocarbon liquid monomer of C_{α}H_{β}, wherein α and β are natural numbers of 5 or more, with a boiling point of about 20° C. to about 350° C.

10. The method according to claim 9, wherein the hydrocarbon liquid monomer has a benzene ring.

11. The method according to claim 9, wherein the liquid monomer has a carbon/hydrogen ratio (C/H) of 0.5 or higher.

12. The method according to claim 10, wherein the hydrocarbon gas is mesitylene.

13. The method according to claim 1, wherein the hydrocarbon gas is the only precursor gas.

14. The method according to claim 1, wherein the inert gas is Ar, He, Ne, Kr, and/or N₂.

15. The method according to claim 1, wherein the hydrocarbon-based polymer film is transparent.

16. The method according to claim 1, wherein the substrate subjected to step (i) has a low-k film formed on its surface, and the hydrocarbon-based polymer film is formed on the low-k film as a hard mask.
